(19) United States
(12) Patent Application Publication
(10) Pub. No.: US 2009/0296584 A1
(43) Pub. Date: Dec. 3, 2009

(54) Method and apparatus to support customer premises diagnostics and service simulation via test user interface devices

(75) Inventors: Marc R. Bernard, Miramar, FL (US); Douglas A. Atkinson, Ashburn, VA (US); David H. Liu, Herndon, VA (US); German Garcia, Boca Raton, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Vienna, Inc., Naperville, IL (US)

(21) Appl. No.: 12/156,647

(22) Filed: Jun. 3, 2008

(51) Int. Cl. H04L 12/26; G06Q 30/00

(52) U.S. Cl. 370/241; 705/1

(57) ABSTRACT

Because networks, such as Optical Distributed Networks (ODNs), dynamically change over time as more users and services are added, service providers are challenged to test operational robustness following installation of equipment or provisioning of services or upgrades. Example embodiments of the present invention allow testing of various services along a communications path, including software upgrades, throughput tests and simulations, and combinations of simulated scenarios with live customer traffic. The example embodiments allow generation of reports based on the testing of various services so that a technician may correct errors and ensure proper provisioning during equipment installation. Such testing may be useful to detect installation or activation problems encountered when a subscriber activates a service at a later date or adds additional devices. The example embodiments simplify installation and provisioning, saving service providers cost on a per installation or provisioning basis.

### BACKGROUND OF THE INVENTION

A Fiber-to-the-Premises (FTTP) network architecture, including a Passive Optical Network (PON), extends optical fiber directly to subscribers' premises. According to the FTTP network architecture, an Optical Network Terminal (ONT) is placed on the subscribers' premises, typically inside the premises. In a typical FTTP deployment, a single network element, such as an Optical Line Terminal (OLT), in a Central Office (CO) may monitor and manage active components of numerous ONTs. Service providers employing the FTTP network architecture experience high costs in bringing optical fiber to customers' premises.

Lengthy installation, itself, at the customer premises is very expensive to the service provider and disruptive to the customer. Despite this, after installation, an installation technician is not sure whether the installation connection is acceptable. Therefore, there is a possibility that there may be a problem with this customer's service at the time of installation, according to the activated services, or at a time after the time of installation if additional services are activated.

### SUMMARY OF THE INVENTION

An embodiment of the present invention may be in a form of an apparatus, network employing the apparatus, or a method of validating a service access path in a point-to-multipoint communications network. A service validation mode of a central distribution node coupled to a given service access path is activated based on a service validation activation signal from a given service access node in communication with the given service access path. A service validation mode of at least one other service access node, if present and in communication with the central distribution node via at least one other service access path, is also activated. The central distribution node and at least one other service access node, if present, are caused to execute at least one service validation operation. A service validation indication is reported at the given service access node based on the at least one service validation operation in the point-to-multipoint communications network.

An alternative embodiment includes a method of generating revenue through sale of service for validating a service access path in a point-to-multipoint communications network. The method includes providing access to a central distribution node to validate the service access path between a given service access node coupled to the service access path and a central distribution node coupled to the service access path, and validating the service access path. The method also includes storing a service validation indication at the given service access node and collecting a fee for the validation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram illustrating a point-to-multipoint communications network employing an apparatus for validating a service access path in the point-to-multipoint communications network.

FIGS. 2A-2E are diagrams illustrating example embodiments of the present invention including example embodiment UID test devices coupled to a NID.

FIG. 3 is a flow diagram illustrating a method of validating a service access path in a point-to-multipoint communications network.

FIG. 4 is a flow diagram illustrating initial behaviors of a UID test device when entering a test mode.

FIGS. 5-7 are flow diagrams illustrating behaviors of a UID test device in test modes with a remote server and with and without the cooperation of an Optical Line Terminal (OLT), respectively.

FIG. 8 is a flow diagram illustrating a method of generating revenue through sale of service for validating a service access path in a point-to-multipoint communications network.

### DETAILED DESCRIPTION OF THE INVENTION

A description of example embodiments of the invention follows.

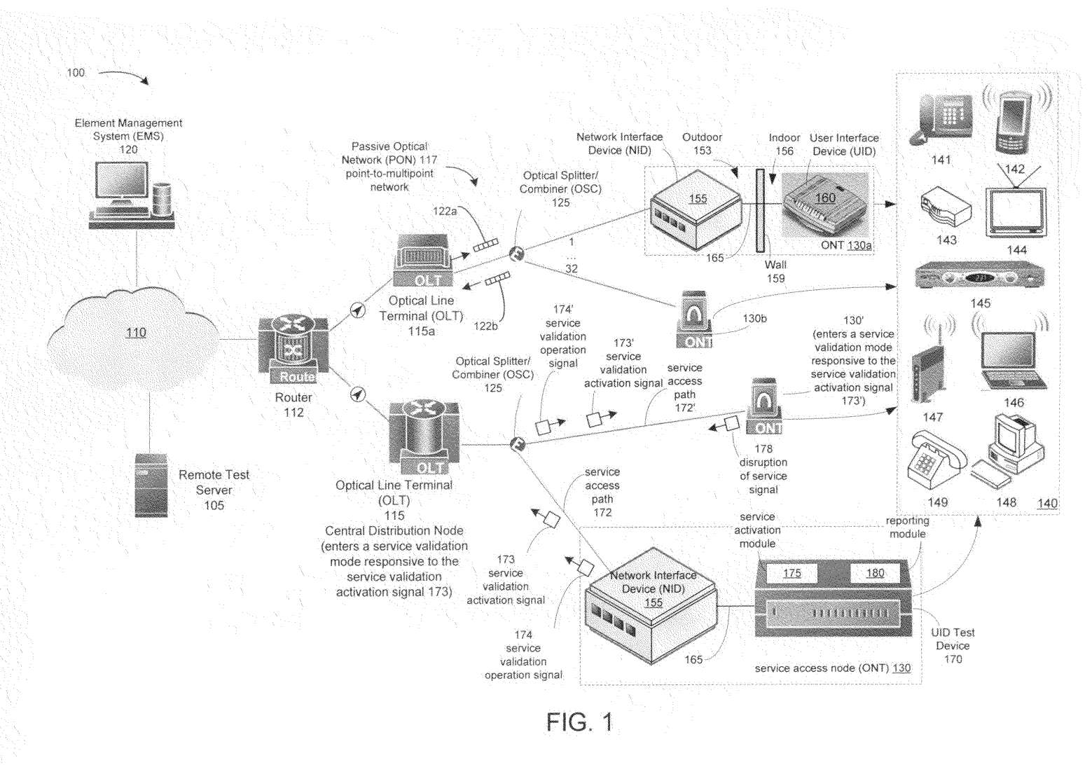

FIG. 1 is a block diagram of a network 100 in which example embodiments of the present invention may be employed. The network 100 includes a Wide Area Network (WAN) 110 and a point-to-multipoint network, such as a Passive Optical Network (PON) 117. The WAN 110 may be a network such as the Internet, and the PON 117 is typically a more localized network in which optical signals, used to transmit information, traverse passive optical elements, such as splitters and combiners, to be communicated between network nodes.

The example network 100 of FIG. 1 includes one or more central distribution nodes, such as Optical Line Terminals (OLTs) 115, an Element Management System (EMS) 120, Routers 112 and servers, such as a Remote Test Server 105, all connected, generally, by the WAN 110. In the example network 100, each OLT 115 transmits/receives information in the form of a frame of packets 122a, 122b embodied on optical signals to/from an optical splitter/combiner (OSC) 125 to communicate with, for example, thirty-two service access nodes, such as Optical Network Terminals (ONTs) 130. The ONTs 130 provide connectivity to customer premises equipment (CPE) devices 140 that may include Internet Protocol (IP) telephones 141, cellular network equipment 142, analog telephone adapters (ATAs) 143, video devices (e.g., televisions 144 and digital cable decoders/set-top boxes (STBs) 145), computer terminals/personal computers (PCs) 146, 148, Broadband Home Routers (BHRs) (wired or wireless) 147, standard telephones 149 (e.g., Public Switched Telephone Network (PSTN), digital subscriber line connections, cable modems, wireless access devices, as well as any other conventional, newly developed, or later developed devices that may be supported by the ONT 130.

An ONT 130 may be physically divided into a Network Interface Device (NID) 155, located in the outdoor 153 of a customer premises, and a User Interface Device (UID) 160, located in the indoor 156 of the customer premises, as disclosed in U.S. patent application Ser. No. 12/002,318 filed Dec. 14, 2007, the entire teachings of which are incorporated herein by reference. The NID 155 performs an optical-to-electrical conversion for downstream data for processing by the UID 160 and an electrical-to-optical conversion for upstream data from the UID 160. Further, the NID 155 may provide electrical power to the UID 160, including battery backup power when AC main power becomes unavailable. A composite cable 165 may be connected through a wall 154 of a customer premises between the NID 155 and the UID 160 to carry electrical power as well as the service provider's data payload, including voice, data, video, physical layer information, such as converted Physical Layer Operations, Administration and Maintenance (PLOAM) cells or special protocol packets, and management data, such as ONT Management Control Interface (OMCI) channel data and upgrade data.

Installation or activation problems may be encountered when a subscriber activates a service at a later date or adds additional CPE devices 140. For example, a service technician may install the NID 155 a first time of installation and test connectivity for basic services, such as telephone, data, and video. However, the technician does not go through an entire test cycle of the home network to ensure or validate that the NID 155 properly operates or that its physical connection to the PON 117 or similar network is clean and acceptable because they do not have the test equipment, the home network currently does not have all required actual equipment to perform the tests, and there is no time to perform this thorough analysis. The UID 160 may not be installed until a later second time of installation.

With existing integration models, it is extremely difficult to test all these scenarios and extremely time-consuming to enable/disable all services to then perform these scenarios. These are often scenarios that the equipment manufacturer should test in their laboratories or facilities prior to deploying the product. However, laboratory testing often occurs in controlled scenarios where provisioning is known ahead of time and there are controlled devices connected to the ONT, ONT and Broadband Home Router (BHR), or UID and NID. Furthermore, as interoperability becomes a major concern for many service providers, it will become less likely that all possible scenarios are thoroughly tested. Finally, the difference between the laboratory environment and the real-world environment is how devices are configured and, alarms are reported, in conjunction with other devices that have been active for periods of time. These different uncontrolled scenarios may have a direct or indirect impact on the current or future quality of service of the existing ONT product.

An apparatus, such as a UID test device 170, may test the validity of a service access path 172 in the point-to-multipoint communications network 117. The apparatus 170 includes an activation module 175 and a reporting module 180. The UID test device 170 may be connected to the NID 155 and may be capable of simultaneously communicating with CPE devices 140. Although the UID test device 170 is not required to be connected to CPE devices 140 to perform simulated tests, the UID test device 170 may be so connected so that it communicates with CPE devices 140 while simultaneously generating internal test traffic to combine with the live traffic from the CPE devices 140.

The activation module 175 causes the given service access node 130 to transmit a service validation activation signal 173 to the central distribution node 115 to cause the central distribution node 115 to enter a service validation mode so that the central distribution node 115 may validate a service access path 172 between a service access node 130 connected to the service access path 172 and the central distribution node 115 connected to the service access path 172. The activation module 175 also causes, via a second service validation activation signal 173′, at least one other service access node 130′, if present and in communication with the central distribution node 115 via at least one other service access path 172′, to enter a service validation mode.

Further, the activation module 175 causes the central distribution node 115 and at least one other service access node 130′, if present, to execute at least one service validation operation. Service validation operation(s), which may be transparent to the central distribution node 115 meaning that the central distribution node 115 is not aware that operations are being performed, may include operations in which the service access node(s) 130, 130′ is aware of the operation or services in which something is needed by a CPE device, such as a PC or STB. These services may include File Transfer Protocol (FTP) downloads, file sharing, online music, online video, World Wide Web (WWW) browsing, or other special patterns for Internet or other typical users. These services also may include other services that may be known to the node(s) 130, 130′, such as Internet Protocol Television (IPTV), multicast, Session Initiation Protocol (SIP) services to the network, SIP services to other ONTs, data services to other ONTs or video services to other ONTs. If the ONT has integrated BHR capabilities, services may include layer 3 functions in the customer premises (e.g., home), such as gaming, peer-to-peer applications, printer client/server applications, WiFi to devices, firewall tests and features, Internet Group Management Protocol (IGMP) communications, or replications. Further, they may include business service applications or other applications with different forms of user traffic. Combinations of ONTs and UIDs on the PON may perform simultaneous tests to check the validity of OLT operations, such as rogue ONT tests in which multiple ONTs work with each other or with a remote server to test the OLT's reaction to a rogue ONT (i.e., an ONT that has a transmitter constantly enabled and which is “splattering” the PON). This test determines how long the OLT takes to react and shut down all other ONTs on a PON in an attempt to isolate the rogue ONT. Once this test is performed, the results are stored and collected for later use and analysis.

The reporting module 180 reports a service validation indication at the given service access node 130 based on the at least one service validation operation. The service validation indication may include pass, fail, or other indication indicating a problem is found that does not presently affect service. The reporting module 180 may report the service validation indication via a light or light emitting diode (LED), indicating via a display or graphical user interface (GUI), or audibly notifying by Plain Old Telephone Service (POTS) or Dual-Tone Multi-Frequency (DTMF). The reporting module 180 may be in a special test device or the actual service access node. Alternatively, the reporting module 180 may report the service validation indication via a reporting signal (not shown) to the central distribution node 115 or via the central distribution node 115 to a management node, such as the EMS 120 or the remote test server 105.

If at least one other service access node 130′ is present, the at least one other service access node 130′ monitors service from the central distribution node 115 and transmits an indication 178 of a disruption in service, if detected, to the central distribution node 115. The at least one other service access node 130′ and the central distribution node 115 may execute operations to validate continuity and functionality of the given service access path 172. Services that may be provided by the central distribution node 115 to the given service access node 130 may include voice service, analog video service, digital video service, Voice over Internet Protocol (VoIP) service, Internet protocol television (IPTV) service, unicast service, local diagnostic service, and upstream communication service. Further, validation operations may include a subset of available alarms, notification, or metrics.

The network 100 may further include a remote test server 105 that collects and correlates information corresponding to the operations. The information may include in-band or out-of-band communications from any service access node 130, 130′. The network 100 also may include the EMS 120 that enables and disables service with specific alarms, with the remote test server 105 collecting and correlating communications between the EMS 120 and the remote test server 105.

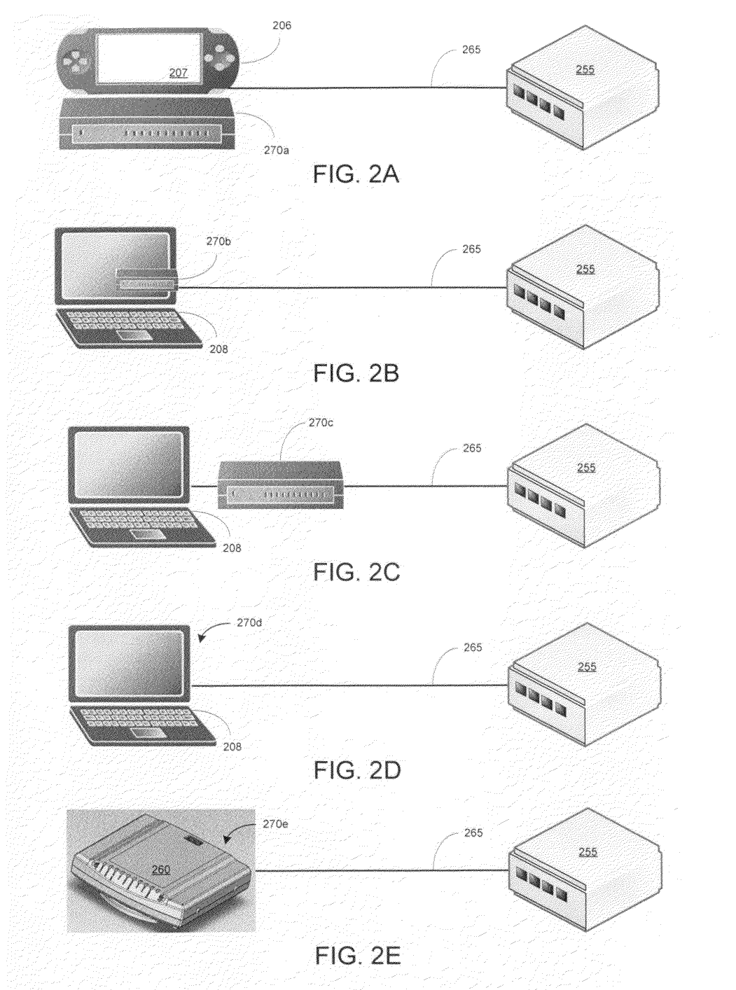

FIGS. 2A-2E are diagrams illustrating example embodiments of the present invention in illustrating example embodiment UID test devices 270 coupled to a NID 255.

FIG. 2A is a diagram illustrating an example embodiment standalone UID test device 270a with a physical connection 265 to an NID 255. The UID test device 270a may have a user interface 206 with a display 207 to permit a technician to communicate with the UID test device 270a. The display 207 may include light emitting diodes (LEDs), a liquid crystal display (LCD), or a video port or craft port that is connected to a separate device, such as a personal computer (PC). The UID test device 270a may connect to CPE devices (not shown) or may have the ability to simulate these different home services.

FIG. 2B is a diagram illustrating an example embodiment integrated UID test device 270b in a PC, such as a technician's laptop computer 208. The UID test device 270b, connected to the laptop computer 208 for example via a Personal Computer Memory Card International Association (PCMCIA) slot or installed within the laptop computer 208, may be coupled to a NID 255 via a cable 265. The UID test device 270b allows the technician to perform all operations directly with the laptop computer 208 via a software application installed on the laptop computer 208 that controls the integrated UID test device 270b and causes it to perform processing necessary to the applicable tests.

FIG. 2C is a diagram illustrating an example embodiment UID test device 270c connected externally to a PC, such as a technician's laptop computer 208. The UID test device 270c, connected to the laptop computer 208 for example via a Universal Serial Bus (USB) port, Ethernet or wireless, may be coupled to a NID 255 via a cable 265. This external UID test device 270c is, therefore, similar to a UID (e.g., UID 160 of FIG. 1) and may be powered from by alternating current (A/C), by a battery, or by a device to which it is connected, such as the laptop computer 208. The UID test device 270c allows the technician to perform all operations directly with the laptop computer 208 via a software application installed on the laptop computer 208 that controls the integrated UID test device 270c and causes it to perform processing necessary to the applicable tests.

FIG. 2D is a diagram illustrating an example embodiment UID test device 270d with test functions performed by a PC, such as a technician's laptop computer 208. The UID test device 270d is connected to a NID 255 via a special cable 265. The UID test device 270d allows the technician to perform all operations directly with the laptop computer 208 via a software application installed on the laptop computer 208 that causes it to perform processing necessary to the applicable tests and operations typically performed by other UID test devices, such as those described with reference to FIGS. 2A-2C, over the special cable 265 connected to the NID 255.

FIG. 2E is a diagram illustrating an example embodiment UID test device 270e with test functions performed by a standalone test unit 260 that is identical to the actual UID to be deployed (e.g., UID 160 of FIG. 1). The UID test device 270e is connected to a NID 255 via a special cable 265. This embodiment of the UID test device 270e employs the existing device 260 itself, but requires special software on the existing device to perform all tests. The UID test device 270e may have its test functions included as part of a special software load or as part of a special feature in existing software. Such features could be activated via a password, software key, backdoor, craft port, or by an OLT. Because the existing UID 260 has user interfaces, such as POTS, data and video, the UID test device 270e can perform simulation and live traffic scenarios. Such embodiments may require different hardware having more memory and greater processing capabilities than a traditional UID (e.g., UID 160 of FIG. 1), but in all other respects would be functionally the same except for the enhanced software capabilities. This UID 210 may communicate directly with an OLT (not shown) of the PON or may have a special port to be accessed by a Technician either directly or via a separate device, such as a PC, laptop computer, or handheld device.

In the above example embodiment described with reference to FIGS. 2A-2E, the UID test device 270a-270e may have interfaces for the CPE devices supporting services, such as voice, data and video. When simulating these services, the UID test device 270a-270e may test the services in combination with live service traffic to or from CPE devices that may be connected to the ONT. Alternatively, the UID test device 270a may simulate the services only or may allow live service traffic only and gradually activate certain simulated services. Although the above example embodiments are described with reference to a NID of an ONT physically separated into a UID and a NID, other example embodiments may be applied to a physically separated ONT (e.g., ONT 130a of FIG. 1) or a traditional ONT (e.g., ONT 130b of FIG. 1). Moreover, the UID test device may perform ONT functions.

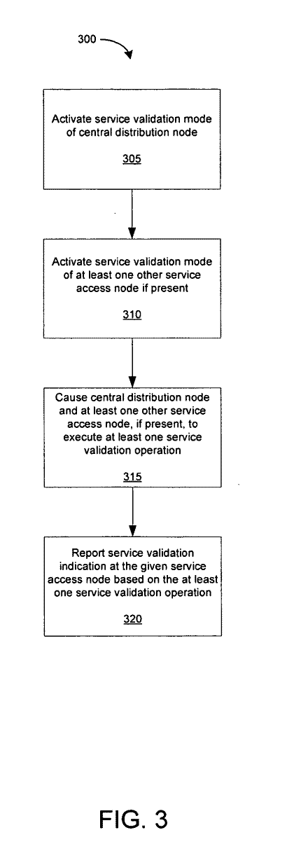

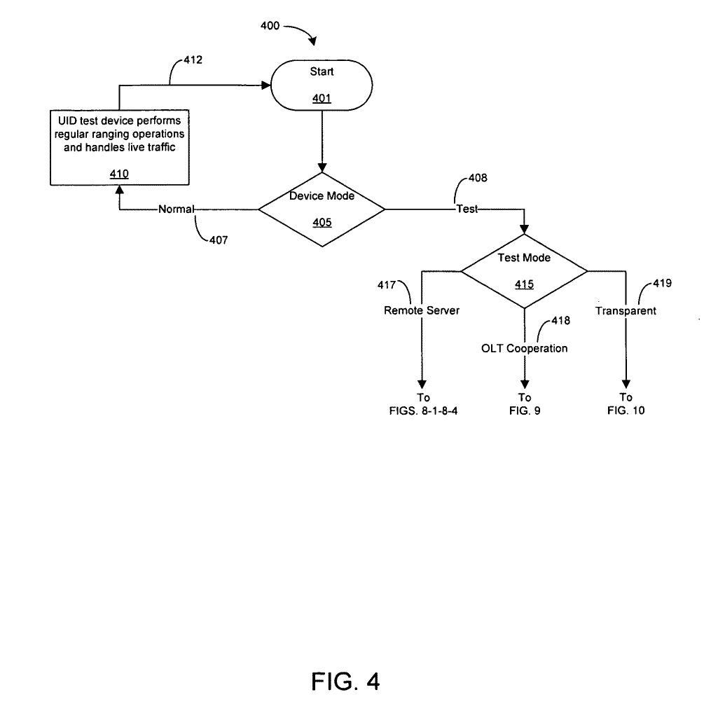

FIG. 3 is a flow diagram 300 illustrating a method of validating a given service access path in a point-to-multipoint communications network. A service validation mode is activated (305) at a central distribution node coupled to the given service access path based on a service validation activation signal from a given service access node coupled to the given service access path. A service validation mode is activated (310) of at least one other service access node if present and connected to the central distribution node via at least one other service access path. The central distribution node and at least one other service access node, if present, are caused to execute (315) at least one service validation operation. A service validation indication is reported (320) at the given service access node based on the at least one service validation operation in the point-to-multipoint communications network.

FIG. 4 is a portion of a flow diagram 400, that illustrates initial behaviors of a UID test device after entering a test mode. After starting (401), during which the UID test device is ranged so that Test Mode may be invoked, the UID test device determines (405) in which mode it is to operate. The UID test device may maintain its mode across reboots, which may be required by some tests performed by the UID test device. During operation, the UID test device operates in a Normal (407) Mode. Therefore, the UID test device may perform its regular ranging operations and handle live traffic (410). The UID test device then continues (412). This example embodiment UID test device may range the UID test device and discover (408) that it is in a Test Mode or has pre-configured knowledge that it is to be in Test Mode.

Test Mode may be invoked locally by a technician with access to the UID test device or remotely by an OLT. In Test Mode, the UID test device may require coordination with the OLT to perform certain test scenarios. The OLT may perform certain functions for the UID test device, such as declare particular alarms to notify the EMS that the UID test device is in Test Mode. If the OLT is aware that the UID test device is in Test Mode, it also may generate certain reports or performance monitoring (PM) statistics reports for the ONT associated with the UID test device or, alternatively, for all ONTs connected to it to determine how tests simulated on one ONT will impact the overall network. If the OLT or EMS is capable of invoking a UID test device to enter a Test Mode, they may support the ability to invoke Test Mode on all ONTs to determine the overall network behavior and generate reports accordingly. In Test Mode, the UID test device may communicate with a far-end device which then communicates different provisioning options on the EMS or OLT to allow certain commands to be sent down to the UID test device so that the UID test device may test the different scenarios and simulate the different CPE device traffic

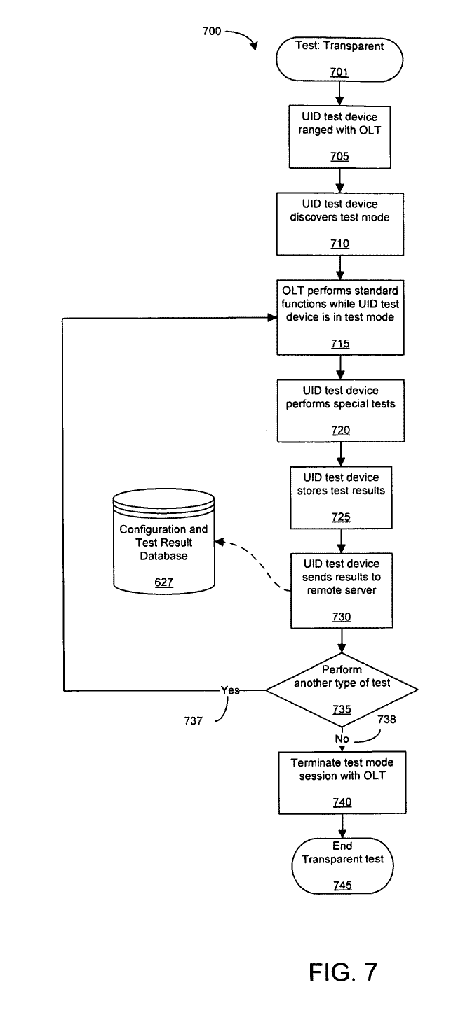

Test scenarios to be performed on a given device will depend on the type of UID test device in the field. For example, some UID test devices may only be able to perform basic configuration tests, upgrade tests, alarm tests, or performance monitoring tests. Other UID test devices also may be capable of simulating user traffic patterns. There are three test modes available to the UID test device: Remote Server (417) (described below with reference to FIGS. 5-1 through 5-4), OLT Cooperation (418) (described below with reference to FIG. 6), and Transparent (419) (described below with reference to FIG. 7).

FIGS. 5-1 through 5-4 are portions of a flow diagram 500, the portions illustrating a Remote Server Test Mode of a UID test device (as selected (417) in FIG. 4).

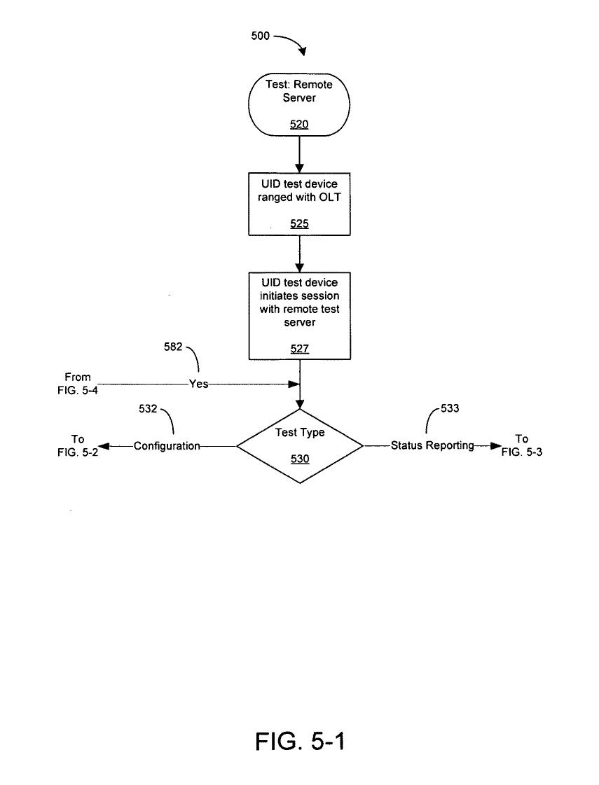

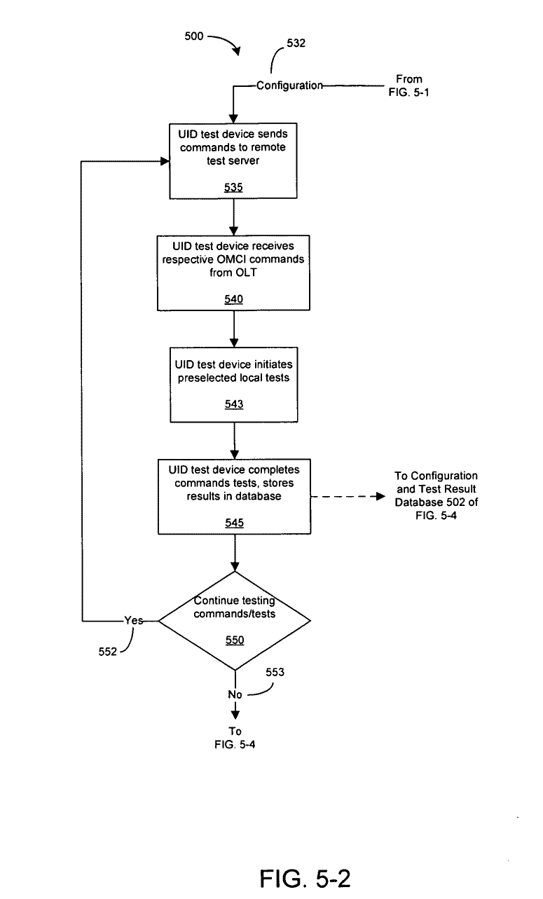

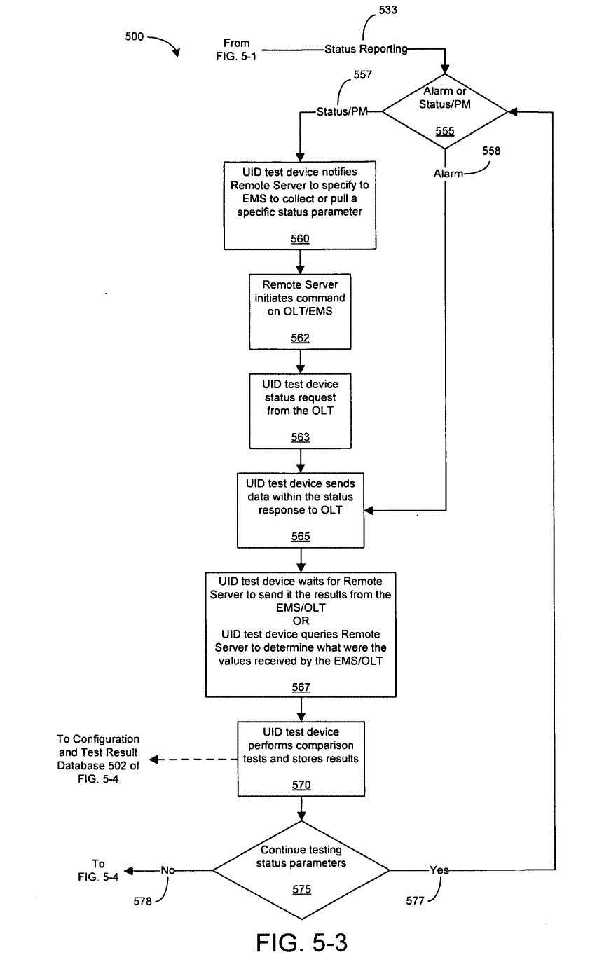

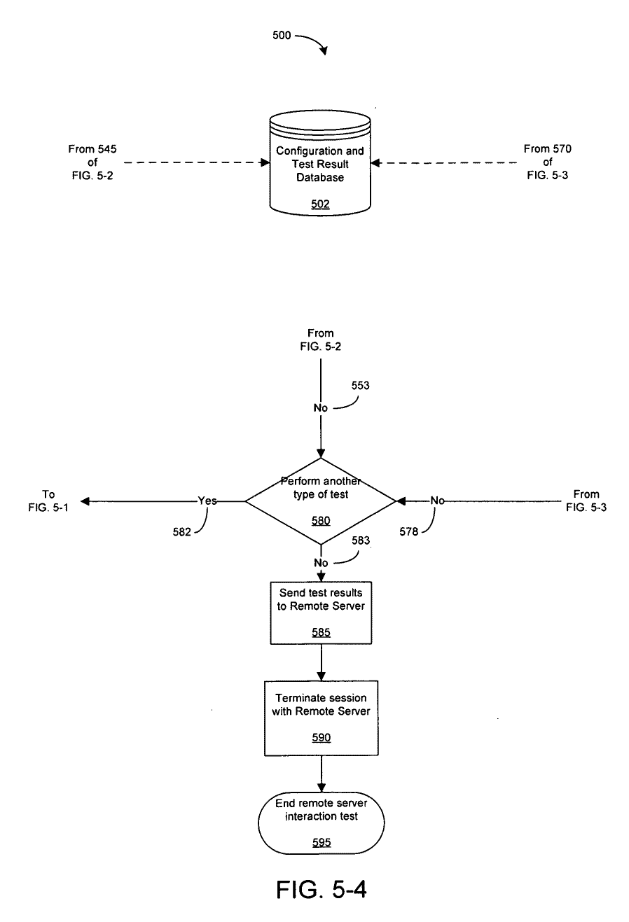

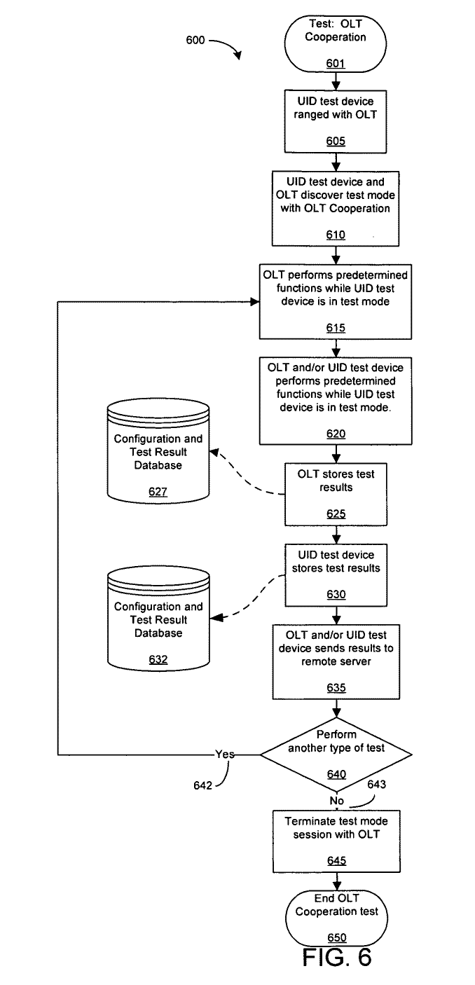

FIG. 5-1 is a portion of a flow diagram 500 illustrating the initial functions of the UID test device entering Remote Server Test Mode. First Remote Server Test Mode is invoked (520). In this example embodiment, the UID may send commands to the Remote Server (i.e., acts as the master) or may receive commands from the Remote Server (i.e., acts as the slave). The UID test device is then ranged (525) with the OLT. In this example embodiment, the UID test device mode may be transparent with the Remote Server such that the UID test device performs its operations transparently from the OLT. Then the UID test device initiates (527) a session with the Remote Server. In the example embodiment, the Remote Server receives commands from the UID test device but then sends commands to the EMS or OLT to configure special parameters on the UID test device. The UID test device then determines (530) its test types: Configuration (532) (described below with reference to FIG. 5-2) or Status Reporting (533) (described below with reference to FIG. 5-3).

FIG. 5-2 is a portion of a flow diagram 500 illustrating functions of the UID test device in a Configuration test (532) of Remote Server Test Mode (520). This test (532) allows an OLT to configure different provisioning attributes and ensures all data is configured as expected. Upon entering a Configuration (532) test, the UID test device sends commands (535) to the Remote Server which then communicates with an EMS to test the different configuration options. The UID test device then receives (540) respective OMCI commands or similar provisioning commands from the OLT. The UID test device also tests that the received commands are what the UID test device commands the Remote Server to configure in the EMS or OLT. The UID test device then initiates (543) a pre-selected local test. These tests may include download tests, throughput tests, and service tests. Throughput and other tests may require interaction with the Remote Server or other UID test devices to test certain capabilities. The UID test device completes (545) commands tests and stores results in a Configuration and Test Result Database (not shown) (e.g., configuration and Test Results Database 502 of FIG. 5-4). The UID test device then determines (550) whether to continue testing additional commands. If there are more commands to test (552), the method repeats (535). If not (553), the method continues to optionally perform another test (e.g., decision box (580) of FIG. 5-4).

This test may require that the UID test device communicate with a test server, which then communicates with an EMS to test the different configuration options. In this scenario, the UID test device notifies the test server how it wants to be configured, with the test server sending commands to the EMS which are then propagated to the ONT employing the UID test device. The ONT compares the requested configuration and the resultant configuration to determine if everything is as expected.

FIG. 5-3 is a portion of a flow diagram 500 illustrating functions of the UID test device in a Status Reporting test (533) of Remote Server Test Mode (520). This Test Mode (533) allows a UID test device to determine the status of a UID test device's performance monitoring and alarms. Upon entering a Status Reporting test (533), the UID test device determines (555) whether it should test alarms or status. If status (557), the UID test device notifies the Remote Server to specify to the EMS to collect or pull a specific status parameter. At step 562, the Remote Server initiates commands on the OLT or EMS. At step 563, the UID test device receives status requests from the OLT. Next, even if alarms are being reported 558, the UID test device sends 565 data within the status response to the OLT. At step 567, the UID test device waits for the Remote Server to send it the results from the EMS or OLT, or the UID test device queries the Remote Server to determine what were the values received by the EMS or OLT. The UID test devices then performs 570 all comparison tests and stores results in Configuration and Test Results Database 502 of FIG. 5-4. The UID test device then determines whether it is to continue testing additional status parameters 575. If it is 577, the method returns to step 555. If not 578, the method continues to step 580 of FIG. 5-4.

The UID test device may generate specific performance monitoring and status values or generate alarms, which are sent to the OLT or EMS and to a test server. The test server then sends these alarms back to the UID test device for comparison. Performance monitoring and status reports are typically requested by the OLT or EMS, so this requires the Remote Server to pull the values via the EMS and then send them to the UID test device for comparison. Another example would be the testing of the Dying Gasp command which requires the UID test device (or ONT) to lose communications with the OLT. In example embodiments of the present invention, the UID test device notifies the Remote Server that a Dying Gasp command will be transmitted and initiates this alarming scenario to ensure that the OLT declares the alarm to the EMS which, in turn, sends the alarms to the Remote Server for data gathering.

FIG. 5-4 is a portion of a flow diagram 500 illustrating closing functions of the UID test device exiting Remote Server Test Mode. The UID test device determines (580) whether it is to perform another type of test. If yes (582), the method returns to the Test Type decision box (530 of FIG. 5-1). If not (583), the UID test device sends (585) test results to the Remote Server and terminates (590) its session with the Remote Server. The Remote Server interaction test then ends (595).

FIG. 6 is a flow diagram 600, illustrating an OLT Cooperation Test Mode of a UID test device (as selected (418) in FIG. 4). Some information, such as demographic information or other information, may be sent to the OLT to be stored for future use. This allows the OLT to know what this user's demographics are expected to be. This information can further be utilized by the OLT to perform further comparisons or tests with the demographics of other devices in the network to determine if there is a risk of the network experiencing throughput, bottleneck or latency issues due to the expected traffic models from all users.

After invoking the OLT Cooperation test 601, the OLT ranges (605) the UID test device. The UID test device and OLT then discover (610) the test mode with OLT Cooperation. This may be discovered in multiple ways, including pull and push functions. For example, the OLT may be configured to command the UID test device to go into test mode, the UID test device may be a Test Mode-only device, or a technician interacting with the UID test device may command it to go into test mode. The OLT also may perform other tests in combination with other UID test devices or ONTs to provide overall network-wide test results based on simulations and/or live traffic tests.

The OLT then performs (615) predetermined functions while the UID test device is in Test Mode. Special functions may include sending a special software load for the actual UID, sending a special software load for a UID test device, and allowing voice/data/video traffic to flow to or from a specific unlink or specific flow. The OLT and/or UID test device performs (620) predetermined functions while the UID test device is in Test Mode. Tests may be performed uniquely by one device or by both devices. The OLT then stores (625) the test results in a first Configuration and Test Results Database 627. The UID test device then stores (630) test results in a second Configuration and Test Results Database 632. The UID test device determines (640) whether it is to perform another type of test. If yes (642), the method returns to perform (615) predetermined functions. If no (643), the UID test device terminates (645) its session with the OLT. The OLT Cooperation Test then ends (650).

FIG. 7 is a flow diagram 700, illustrating a Transparent Test Mode of a UID test device (as selected (419) in FIG. 4). After invoking the Transparent Test Mode (701), the OLT ranges (705) the UID test device. The UID test device then discovers (710) the test mode. This may be discovered in multiple ways, including pull and push functions. For example, the OLT may be configured to command the UID test device to go into test mode, the UID test device may be a Test Mode-only device, or a technician interacting with the UID test device may command it to go into test mode. Although the OLT may be configured to command the UID test device to go into test mode, there is no interaction and no special OLT behavior when the UID test device is in this test mode. All tests and simulations are performed by the UID test device itself.

The OLT then performs (715) standard functions while the UID test device is in Test Mode. Standard functions may include attempting to download particular software images, configure standard services for the UID test device, and route traffic link any other traffic from other “live” ONTs on the network. In general, the OLT does not do anything different for the UID test device than it would for a traditional ONT. The UID test device performs (720) special tests on traffic, receives commands from the OLT, downloads software images and initiates user services. The UID test device then stores (725) test results in a Configuration and Test Results Database 727. The UID test device then sends (730) results to a Remote Server. The UID test device then determines (735) whether it is to perform another type of test. If yes (737), the method returns to perform (715) standard functions. If no (738), the UID terminates (740) the Test Mode session. The Transparent test then ends (745).

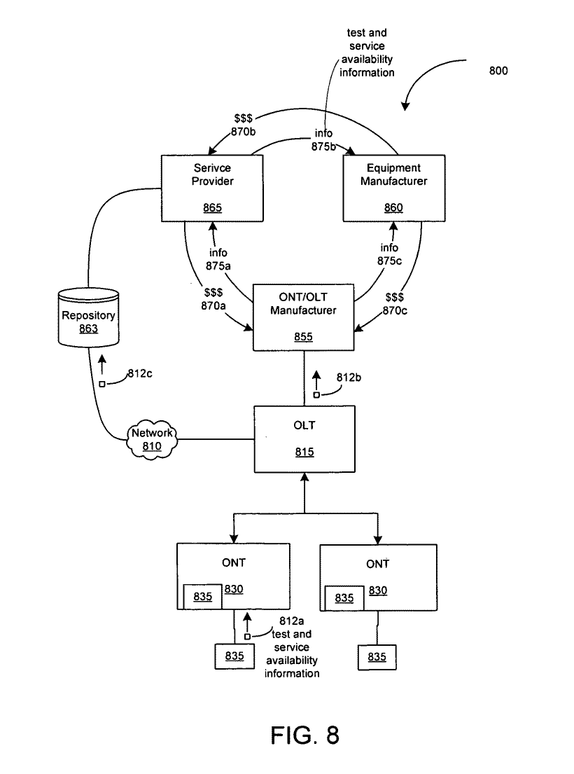

FIG. 8 is a block diagram annotated with arrows illustrating example flows of test and service-availability information associated with validating a service access path in a point-to-multipoint communications network (e.g., test and service availability information resulting from the tests described with reference to FIGS. 4-7) and value (e.g., money) exchanged by various parties for the information or access to the information. An example method includes providing access to a central distribution node to validate a service access path between a given service access node connected to the service access path and a central distribution node connected to the service access path, and validating the service access path. The method also includes collecting a fee for the validation.

In this example embodiment, an ONT/OLT manufacturer 855 may collect information 812a about UID test devices 825 deployed in the field. The UID test device 825 may be connected internal to or external from the ONT 820, with up to thirty-two ONTs connected in a PON 800 to an OLT 815. The ONT/OLT manufacturer 855 may maintain the information 812b or, alternatively, may pass the information 812c over a network 810 to store it in a repository 863. With the information available directly from the ONT/OLT manufacturer 812b or in the repository 863, the ONT/OLT manufacturer 855 may then collect a fee 870a, 870c for the information 875a, 875c from other parties, such as an equipment manufacturer 860, service provider 865, or third party (not shown). Services may include voice, data and video.

The fee 870a, 870c may be collected on a subscription service fee basis, per-subnetwork basis, per-ONT 825 basis, per-equipment manufacturer 860 basis, or per-ONT 825 model number basis. The fee also may be collected for additional troubleshooting support based on service validation information, providing service validation to a third-party equipment manufacturer engaged in selling equipment and service validation to a service provider, or based on a service contract that includes software updates to remedy a problem detected by the validation.

The data stored in the repository 862 may be made available to a service provider 865 for a fee 870a. In this situation, the service provider 865 may then, as a “middle man,” sell the information 875b to the equipment manufacturer 860 or a third party for a fee 870b. Or, alternatively, the ONT/OLT manufacturer 855 may directly sell the information 875a, 875c to the equipment manufacturer 860, service provider 865 or third party for a fee 870a, 870c.

Software image upgrade testing may require coordination between the OLT and the UID test device to determine the type of software image that is being tested or sent. Further, the UID test device may accept software image upgrade commands by presenting its software image temporarily as an older release, accepting the image, and then decoding the updated software image version in the downloaded code without actually utilizing the downloaded image. Alternatively, the OLT may be aware that the UID test device is requesting a special load and therefore sends a special test version to the UID test device for it to load and use. Moreover, the OLT may be aware that the UID test device is a deployable UID (or ONT) and may send an actual upgrade software image that the UID (or ONT) will actually utilize. The upgraded software image may have enhancements in the regular mode behavior or the “test mode” behavior. The UID test device may not accept software image upgrades via OMCI while it is a test unit. and may only accept software image upgrades via a separate Remote Server or via a local interface. Further, the UID test device may accept software images that then are used to further upgrade the NID.

The UID test device simulates real-world traffic scenarios that a typical customer might encounter. Therefore, the UID test device may be tailored to the type of customer where the device is being installed. For example, an older user may activate different services, such as more IPTV services and more voice services, than a younger user's services, such as high speed Internet, gaming, IPTV, instant messaging, and femtocell/cellular services. The different test scenarios can be created manually or can be generated automatically by entering demographic information about the user and other information, including the number of family members and their age.

Demographic information may be determined by collecting data over time from existing devices in the field (based on performance monitoring of those devices) analyzing it based on known demographics associated with the different devices in the field. Further, surveys may be taken of different age groups to determine what services are most commonly used and how their use impacts traffic models in the customer premises.

These generic and specialized testing scenarios may cover several options, including voice, data, and video services and may test various combinations of traffic to accommodate current and future expected usage patterns. More sophisticated devices will simulate upper layer applications traffic scenarios, different usage loads, different channel changing models, different traffic types with various delays, packets sizes, throughput and combinations thereof.

While the UID test device is performing tests, it may keep track of the test information and results. For example, the UID test device may store information in a local memory, a storage device connected to the UID test device, /or alternatively can upload this data in a remote storage server for later use. Updates may be made periodically, when test results have been completed, or upon request from the remote server. Results may be provided locally to the user as the tests are being performed. The user may see if any errors occur and may make appropriate corrections to provisioning and also to physical connections (such as to the UID, NID or other in-home network devices). Results may determine that the NID itself needs to be replaced or requires additional service, capacity or specific features. Results and reports may be generated not only against the UID test device but also against all devices on the PON or in the network. These network-wide reports may be based on demographics and may provide an expected assessment of the risks foreseen for the network based on the expected traffic that devices will incur in the future.

While this invention has been particularly shown and described with references to example embodiments thereof, it will be understood by those skilled in the art that various changes in form and details may be made therein without departing from the scope of the invention encompassed by the appended claims.

Implementations of flow diagrams illustrating example embodiments may be implemented in a form of hardware, firmware, software, and combinations thereof. If implemented in software, the software may be any suitable language, stored on a computer-readable medium, and be loaded and executed by a processor. The processor can be any general or application-specific processor that can execute the software in a manner consistent with the principles of the present invention, as claimed and illustrated by the example embodiments presented herein.

Example embodiments of the present invention allow the UID test device to perform a range test using a special serial number that may allow an OLT to know that it is a UID test device to be ranged so that specials alarms, counters or behaviors may be enabled. The special serial number may be preconfigured in the OLT. Moreover, the UID test device may be detected by some other characteristic, such as ONT type, manufacturer, software version or hardware version. Further, throughput tests or simulations and combinations of simulated scenarios may be performed with live service traffic. Moreover, a service provider may generate reports based on the different tests performed to allow a technician to make corrections during installation or to ensure that provisioning is appropriate in the service provider's central office, such as at an EMS or OLT.

What is claimed is:

1. A method of validating a service access path in a point-to-multipoint communications network, the method comprising:
activating a service validation mode of a central distribution node coupled to a given service access path based on a service validation activation signal from a given service access node coupled to the given service access path;
activating a service validation mode of at least one other service access node if present and coupled to the central distribution node via at least one other service access path;
causing the central distribution node and at least one other service access node, if present, to execute at least one service validation operation; and
reporting a service validation indication at the given service access node based on the at least one service validation operation in the point-to-multipoint communications network.

2. The method of claim 1 wherein at least one other service access node is present and wherein causing the at least one other service access node to execute the at least one service validation operation includes causing the at least one other service access node to monitor service from the central distribution node and to transmit an indication of a disruption in service, if detected, to the central distribution node.

3. The method of claim 1 wherein causing execution of the at least one service validation operation includes executing operations to validate continuity and functionality of the given service access path.

4. The method of claim 3 wherein executing operations to validate functionality of the given service access path includes causing at least one of the following services to be provided by the central distribution node to the given service access node: voice service, analog video service, digital video service, voice-over-internet protocol (IP) service, internet protocol television (IPTV) service, unicast service, local diagnostic service, and upstream communication service.

5. The method of claim 3 wherein the operations include a subset of available alarms, notification, or metrics.

6. The method of claim 1 further comprising:
collecting and correlating information at a remote test server corresponding to the operations.

7. The method of claim 6 wherein the information includes in-band or out-of-band communications from any service access node.

8. The method of claim 1, the communications network further comprising an Element Management System (EMS) and a remote test server, the method further comprising:
collecting and correlating information at the remote test server; and
enabling and disabling service with specific alarms.

9. The method of claim 1 wherein operations are transparent to the central distribution node.

10. The method of claim 1 wherein the point-to-multipoint communications network is a Passive Optical Network (PON).

11. The method of claim 1 wherein the service validation indication further comprises pass, fail, or other indication indicating a problem is found that does not presently affect service.

12. The method of claim 1 wherein reporting further comprises illuminating a light or light emitting diode (LED), indicating via a display or graphical user interface (GUI), or audibly notifying by Plain Old Telephone Service (POTS) or Dual-Tone Multi-Frequency (DTMF).

13. The method of claim 12 wherein the reporting is indicated at a special test device or the actual service access node.

14. A point-to-multipoint communications network comprising:
a central distribution node;
a given service access node;
a service access path coupling the central distribution node and the service access node;
an activation module configured to cause the given service access node to transmit a service validation activation signal to the central distribution node to cause the central distribution node to enter a service validation mode, to cause at least one other service access node if present and coupled to the central distribution node via at least one other service access path to enter a service validation mode, and to cause the central distribution node and at least one other service access node if present to execute at least one service validation operation; and
a reporting module configured to report a service validation indication at the given service access node based on the at least one service validation operation.

15. The network of claim 14 wherein at least one other service access node is present, the at least one other service access node configured to monitor service from the central distribution node and to transmit an indication of a disruption in service, if detected, to the central distribution node.

16. The network of claim 14, the central distribution node and at least one other service access node if present configured to execute operations to validate continuity and functionality of the given service access path.

17. The network of claim 16, the central distribution node and at least one other service access node if present configured to cause at least one of the following services to be provided by the central distribution node to the given service access node: voice service, analog video service, digital video service, voice-over-internet protocol (IP) service, internet protocol television (IPTV) service, unicast service, local diagnostic service, and upstream communication service.

18. The network of claim 16 wherein the operations include a subset of available alarms, notification, or metrics.

19. The network of claim 14 further comprising:
a remote test server configured to collect and correlate information corresponding to the operations.

20. The network of claim 19 wherein the information includes in-band or out-of-band communications from any service access node.

21. The network of claim 14 further comprising:
an Element Management System (EMS); and
a remote test server collecting and correlating communications between the EMS and the remote test server;
wherein the EMS is configured to enable and disable service with specific alarms.

22. The network of claim 14 wherein operations are transparent to the central distribution node.

23. The network of claim 14 wherein the point-to-multipoint communications network is a Passive Optical Network (PON).

24. The network of claim 14 wherein the service validation indication further comprises pass, fail, or other indication indicating a problem is found that does not presently affect service.

25. The network of claim 14 wherein the reporting module is further configured to illuminate a light or light emitting diode (LED), indicating via a display or graphical user interface (GUI), or audibly notifying by Plain Old Telephone Service (POTS) or Dual-Tone Multi-Frequency (DTMF).

26. The network of claim 25 wherein the reporting module is in a special test device or the actual service access node.

27. An apparatus for validating a service access path in a point-to-multipoint communications network, the apparatus comprising:
an activation module configured to cause a given service access node coupled to the given service access path to transmit a service validation activation signal to a central distribution node coupled to the given service access path to cause the central distribution node to enter a service validation mode, to cause at least one other service access node if present and coupled to the central distribution node via at least one other service access path to enter a service validation mode, and to cause the central distribution node and at least one other service access node if present to execute at least one service validation operation; and
a reporting module configured to report a service validation indication at the given service access node based on the at least one service validation operation.

28. The apparatus of claim 27 wherein the point-to-multipoint communications network is a Passive Optical Network (PON).

29. The apparatus of claim 27 wherein the service validation indication further comprises pass, fail, or other indication indicating a problem is found that does not presently affect service.

30. The apparatus of claim 27 wherein the reporting module is further configured to illuminate a light or light emitting diode (LED), indicating via a display or graphical user interface (GUI), or audibly notifying by Plain Old Telephone Service (POTS) or Dual-Tone Multi-Frequency (DTMF).

31. The apparatus of claim 30 wherein the reporting module is in a special test device or the actual service access node.

32. A computer-readable medium having computer-readable code embedded therein to cause a computer, upon execution of the code, to:
activate a service validation mode of a central distribution node coupled to a given service access path based on a service validation activation signal from a given service access node coupled to the given service access path;
activate a service validation mode of at least one other service access node if present and coupled to the central distribution node via at least one other service access path;
cause the central distribution node and at least one other service access node, if present, to execute at least one service validation operation; and
report a service validation indication at the given service access node based on the at least one service validation operation in the point-to-multipoint communications network.

33. A method of generating revenue through sale of service for validating a service access path in a point-to-multipoint communications network, the method comprising:
providing access to a central distribution node to validate a service access path between a given service access node coupled to the service access path and a central distribution node coupled to the service access path;
validating the service access path; and
collecting a fee for the validation.

34. The method of claim 33 wherein collecting the fee for the validation includes collecting the fee on at least one of: a subscription service fee basis, per-subnetwork basis, per-service access node basis, per-service access node manufacturer basis, per-service access node model number basis, and per-service basis.

35. The method of claim 34 wherein services include voice, data, and video.

36. The method of claim 33 wherein collecting the fee for the validation includes collecting the fee for additional troubleshooting support based on service validation information.

37. The method of claim 33 wherein collecting the fee for the validation includes collecting the fee for providing service validation to a third-party equipment manufacturer, the third-party equipment manufacturer engaged in selling equipment and service validation to a service provider.

38. The method of claim 33 wherein collecting the fee for the validation includes collecting the fee based on a service contract that includes software updates to remedy a problem detected by the validation.
